(19) United States
(12) Patent Application Publication
(10) Pub. No.: US 2017/0008744 A1
(43) Pub. Date: Jan. 12, 2017

(54) SELF TIGHTENING BOTTLE CAP OPENER

(71) Applicants: G. PETER MACON, CORNELIUS, NC (US); RAYMOND AARON MEAD, EAST PROVIDENCE, RI (US)

(72) Inventors: G. PETER MACON, CORNELIUS, NC (US); RAYMOND AARON MEAD, EAST PROVIDENCE, RI (US)

(21) Appl. No.: 14/793,470

(22) Filed: Jul. 7, 2015

(51) Int. Cl. B67B 7/18; B67B 7/44; B67B 7/40

(52) U.S. Cl. CPC B67B 7/18; B67B 7/403; B67B 7/44

(57) ABSTRACT

A wrap-around bottle cap opener for removing twisted-on bottle caps and which includes a generally “U” shaped handle and a flexible arm. The handle includes a tab opener/finger recess. The flexible arm extends from the handle and when unbiased forms a wrap that lies adjacent the “U” shaped top of the handle. A low durometer grip is located at the end of the flexible arm. The flexible arm wraps around a bottle cap with the grip contacting the bottle cap. Twisting the handle causes the flexible arm to come into contact with the “U” shape of the handle causing the grip to be forced toward the bottle cap. Additional turning provides a positive engagement with the bottle cap which self-tightens on the bottle cap causing it to twist off.

### FIELD OF THE INVENTION

The presently disclosed subject matter is directed a tool for removing bottle caps from bottles. More particularly, it is directed to a self-adjusting, self-tightening bottle cap opener that assists removing bottle caps from plastic bottles.

### BACKGROUND OF THE INVENTION

Years ago most beverages such as beer and soda as well as other liquids were sold in glass bottles sealed by pressed-on metal caps. Removing a pressed-on metal cap was performed either by using a bottle cap opener or, later, by twisting. While pressed-on metal glass bottles are still used in some applications the disadvantages of glass bottles are readily apparent. They are heavy, take a long time to cool, are relatively expensive, and they break.

Because of the disadvantages of glass bottles distributors turned to metal cans to distribute liquids. While metal cans had been used for decades to store edibles such as beans and fruit modern advances in the packaging arts enabled them to be used with beverages. Initially, metal cans were tin plated steel cans. Such cans are very rugged and are still used in some applications. However, over time tin plated steel cans generally gave way to aluminum cans. Metal cans initially were “opened” by puncturing their tops with a “church key.” Later, pull tabs, pop tops and push-in openings became common. Metal cans have the advantages that they are rugged, save weight, and increase the rates of cooling. They are however relatively expensive and being metal are not clear.

The limitations of both glass bottles and metal cans lead to the development of plastic bottles. Plastic bottles are suitable for many liquids and are just about the only packaging used for distributing water bottles. Plastic bottles can be clear to enable visual inspection of their stored content. Plastic bottles are very light weight, low cost, easily handled, fairly rugged, and enable rapid cooling of their contest. While plastic bottles have some limitations, such as the need to recycle, they have developed a significant niche in packaging technology.

Decades ago it was discovered that total strangers could be poisoned for profit (extortion) or for other reasons (terrorist attack) by contaminating food and beverage items while on display in stores. After several incidents tamper-resistant packaging became mandatory.

Virtually all plastic bottles are sealed using tamper-resistant twist-off bottle caps that are threaded onto the tops of the plastic bottles and “locked” by a visually inspectable plastic ring. When a tamper-resistant twist-off bottle cap is twisted off it leaves behind a “damaged” break-away plastic ring on the bottle. Visual inspection of the integrity of the bottle cap and ring provides positive proof that the plastic bottle has not been previously tampered with. Tamper-resistant twist-off bottle caps not only protect against contamination but they also enable a consumer to remove some of the liquid and to then reseal the plastic bottle.

While highly effective in sealing and protecting against contamination, tamper-resistant twist-off bottle caps can be difficult to remove, especially for the young, the elderly, and others having physical limitations or that lack the necessary hand strength. Even for healthy adults removing twist-off bottle caps can be a chore. The difficulty of removing tamper-resistant twist-off bottle caps is partially because they are usually made a tough, hard plastic such as high density polyethylene (HDPE) or polypropylene (PP). Such materials require a user to break a rather strong lock between the bottle cap and its safety ring. Another cause of the difficulty of removing tamper-resistant twist-off bottle caps is that they are designed to prevent the escape of liquids or gas. Thus they are installed tight enough to provide a gas and liquid seal. As pressure differentials between the interior and exterior of a bottle develop an even stronger “locking force” is created that must be overcome to remove the bottle cap.

In view of the foregoing a bottle cap opener that makes it easier for a user to remove a bottle cap would be beneficial. Even more beneficially would be a bottle cap opener that is fast and easy to use. Preferably such a bottle cap opener would provide a mechanical advantage that reduces the hand strength needed to unscrew a bottle cap. In addition, it would be beneficial if the bottle cap opener provided a secure grip on bottle caps of many different sizes, ensured a positive engagement with the bottle cap, and provided a strong gripping force between the bottle cap and the bottle cap opener. Ideally such a bottle cap opener would be self-adjusting to fit the size of the bottle cap being opened and self-tightening to enable almost everyone to remove a bottle cap from almost any bottle.

### BRIEF SUMMARY OF THE INVENTION

The principles of the present invention provide for a wrap-around, self-adjusting bottle cap opener which makes it easy for a user to remove a twisted-on bottle cap. The wrap-around bottle cap opener provides a mechanical advantage that reduces the hand strength needed to unscrew the bottle cap. The inventive wrap-around bottle cap opener also provides a positive engagement with twist-on bottle caps of many different sizes and provides a positive grip on the bottle cap using a self-tightening grip which mates with the outer perimeter of the bottle cap. The wrap-around bottle cap opener is also easy and convenient to use.

A bottle cap opener that is in accord with the present invention includes a handle having a generally “U” shaped outer perimeter, a flexible arm that extends from the handle and which is biased to form a generally circular wrap adjacent the handle “U”, and a grip at the end of the flexible arm and which is located within the wrap.

The grip is preferably located within the wrap and may be comprised of a low durometer material. The bottle cap opener beneficially includes a finger recess and/or a cap opener for beer or soda bottle tabs on a side opposite the side from which the flexible arm extends. The bottle cap opener may also include a ring aperture through the handle. Preferably the handle is comprised of a hard plastic material such as Acrylonitrile butadiene styrene (ABS), Polyethylene, or Polypropylene. The bottle cap opener can include a direction indicator, preferably on the handle.

The grip should be made from a low durometer material such as is Silicone or a thermoplastic elastomer. The grip includes a tubular body that fits over the end of the flexible arm. The grip also may include a flat face that extends above the tubular body.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a top down view of a wrap-around bottle cap opener 10 that is in accord with the principles of the present invention;

FIG. 2 illustrates the wrap-around bottle cap opener 10 opened to fit on a bottle cap 100; and

FIG. 3 presents a more detailed illustration of the grip 30 at the end of the flexible arm 28.

### DESCRIPTIVE KEY

10 wrap-around bottle cap opener
12 handle
14 cap opener/finger recess
18 ring aperture
26 wrap
28 flexible arm
30 grip
32 direction indicator
40 flat face
42 tubular body
100 bottle cap

### DETAILED DESCRIPTION OF THE INVENTION

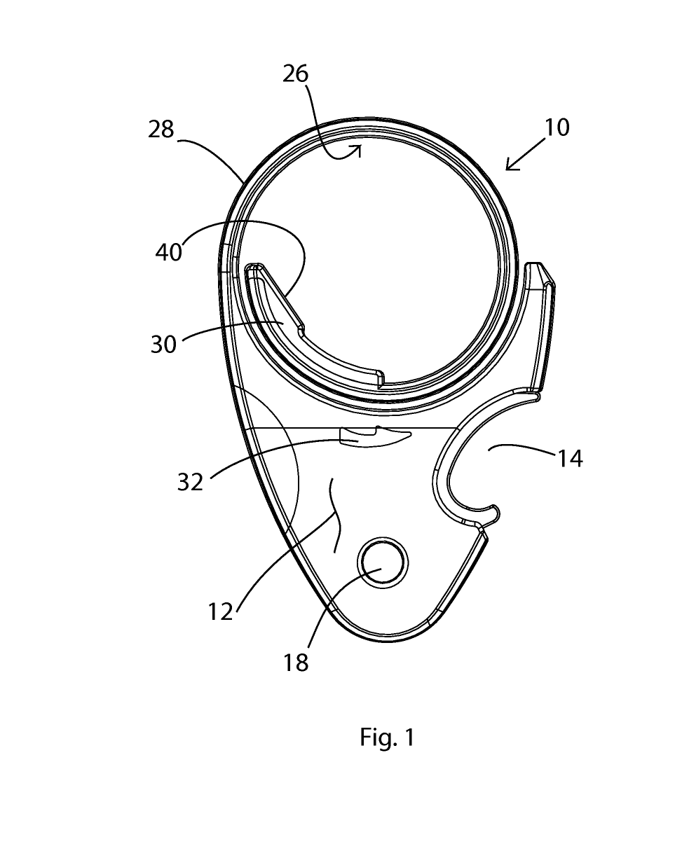

The preferred embodiment of the present invention is depicted in FIGS. 1 through 3. However, the invention is not limited to the specifically described embodiment. A person skilled in the art will appreciate that many other embodiments of the invention are possible without deviating from the basic concept of the invention. Any such work around will also fall under the scope of this invention.

The terms “a” and “an” as used herein do not denote a limitation of quantity, but rather denote the presence of at least one of the referenced items. In addition, unless otherwise denoted all directional signals such as in, out, up, down, left, and right are taken with reference to FIG. 1.

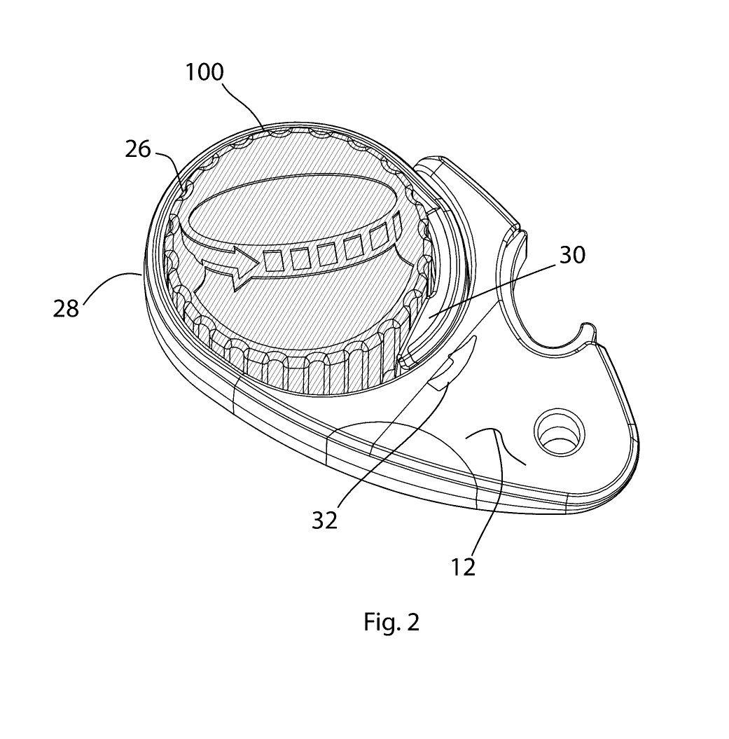

Referring now primarily to FIGS. 1 and 2, the present invention describes a wrap-around bottle cap opener 10 usable for removing bottle caps, such as the plastic bottle cap 100 shown in FIG. 2, from bottles. The basic wrap-around bottle cap opener 10 can assist removal of bottle caps with a wide range of diameters such as from less than 10 mm to over 35 mm. Wrap-around bottle cap openers 10 of different sizes are contemplated for use with both larger and smaller bottle caps.

Referring now primarily to FIG. 1, a wrap-around bottle cap opener 10 includes a handle 12 having a tab opener/finger recess 14 on one side. The tab opener/finger recess 14 is an insert that is used for opening pry off metal beer/soda tabs as well as being an available finger recess to better fit some user's hands.

Except for the tab opener/finger recess 14, which may be a metal insert, the handle 12 is preferably made from a hard plastic material such as Acrylonitrile butadiene styrene (ABS), Polyethylene (PE), or Polypropylene (PP). Neglecting the tab opener/finger recess 14, the handle 12 generally has a “U” shaped outer perimeter. Toward the bottom of the handle 12 is a ring aperture 18. The ring aperture 18 is useful for storing the wrap-around bottle cap opener 10 on a peg such as a nail (not shown) or for receiving a ring, chain, or lanyard, (also not shown) so that the wrap-around bottle cap opener 10 can be used as a keychain or for attachment to an external structure.

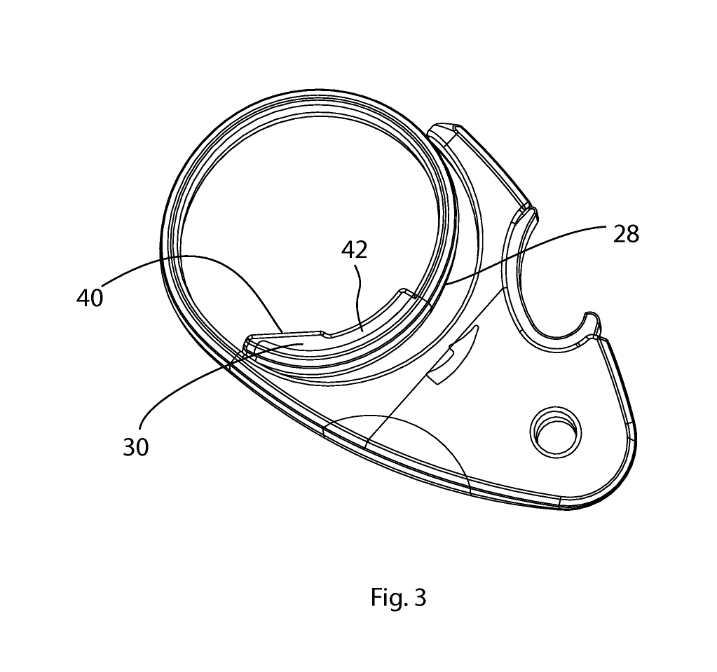

At the top of the handle 12 on the side opposite the tab opener/finger recess 14 is an integral flexible arm 28 that is internally biased to form a generally circular wrap 26 when external force is not applied to the flexible arm 28. The end of the flexible arm 28 terminates in a grip 30, which is also shown in FIG. 3.

Referring now to FIG. 2, the flexible arm 28 can flex outward to enlarge the generally circular wrap 26. This enables the flexible arm 28 to wrap around bottle caps 100 that are larger than the un-flexed generally circular wrap 26.

To remove a bottle cap 100 the flexible arm 28 is opened to fit around a bottle cap 100. Then, the handle 12 is rotated in the direction of the direction indicator 32. This causes the grip 30 to contact the outer perimeter of the bottle cap 100. Most bottle caps 100 have ridges that extend parallel to the central axis of the bottle. As the grip 30 is made of a compliant (low durometer) material the grip 30 tends to “grab” the ridges. Additional rotation of the handle 12 in the direction of the direction indicator 32 forces the flexible arm 28 to contact the “U” portion of the handle 12. This forces the grip 30 toward the bottle cap 100 and causes the grip to partially flow into the bottle cap ridges and thus providing an improved grip. Continued rotation of the handle 12 forces the flexible arm 28 and the grip 30 to twist the bottle cap 100, thus tending to remove it from a bottle.

To assist removing a tab the end of the tab opener/finger recess 14 is fit under the end of the tab and then the tab opener/finger recess 14 is rotated against the lid to pry the tab upwards.

FIG. 3 illustrates the grip 30 in more detail. The grip 30 has a flat face 40 that extends slightly above and at the end of a tubular body 42. The tubular body 42 fits over the end of the flexible arm 28. The grip 30 is preferably made from a thermoplastic elastomer (TPE), Silicone or another low durometer and compliant material.

The foregoing description of a specific embodiment of the present invention has been presented for purposes of illustration and description. It is not intended to be exhaustive or to limit the invention to the precise form that is disclosed. Obviously many modifications and variations are possible in light of the above teaching. The embodiment was chosen and described in order to best explain the principles of the invention and its practical application, to thereby enable others skilled in the art to best utilize the invention and various embodiments with various modifications as are suited to the particular use contemplated.

What is claimed:

1. A bottle cap opener, comprising:
a handle having a generally “U” shaped outer perimeter and a concave top;
a flexible arm extending from said handle, said arm biased to form a circular wrap adjacent said top; and
a grip at an end of said flexible arm and located within said wrap.

2. The bottle cap opener recited in claim 1, wherein said grip is comprised of a low durometer material.

3. The bottle cap opener recited in claim 1, wherein said handle includes a tab opener on a first side.

4. The bottle cap opener recited in claim 3, wherein said flexible arm extends from a second side of said handle.

5. The bottle cap opener recited in claim 1, further including a ring aperture through said handle.

6. The bottle cap opener recited in claim 1, wherein said handle is comprised of Acrylonitrile butadiene styrene (ABS).

7. The bottle cap opener recited in claim 1, wherein said handle is comprised of Polyethylene.

8. The bottle cap opener recited in claim 1, wherein said handle is comprised of Polypropylene.

9. The bottle cap opener recited in claim 1, further including a direction indicator.

10. The bottle cap opener recited in claim 9, wherein said direction indicator is on said handle.

11. The bottle cap opener recited in claim 2, wherein said low durometer material is Silicone.

12. The bottle cap opener recited in claim 2, wherein said low durometer material is a thermoplastic elastomer.

13. The bottle cap opener recited in claim 2, wherein said grip includes a tubular body that fits over the end of said flexible arm.

14. The bottle cap opener recited in claim 13, wherein said grip includes a flat face that extends above said tubular body.

15. A bottle cap opener, comprising:
a handle having a generally “U” shaped outer perimeter with a finger recess on one side and a concave top;
a flexible arm extending from the top of said “U” shaped outer perimeter on a the side opposite said finger recess, said arm biased to form a circular wrap adjacent said top; and
a grip comprised of a tubular body on an end of said flexible arm and a flat face that faces into said circular wrap.

16. The bottle cap opener recited in claim 15, further including a ring aperture through said handle.

17. The bottle cap opener recited in claim 16, further including a direction indicator.

18. The bottle cap opener recited in claim 14, wherein said finger recess acts as a tab opener.

19. The bottle cap opener recited in claim 15, wherein said grip is comprised of a low durometer material.

20. The bottle cap opener recited in claim 19, wherein said grip includes a tubular body that fits over an end of said flexible arm.
